(19) United States
(12) Patent Application Publication
(10) Pub. No.: US 2025/0289379 A1
(43) Pub. Date: Sep. 18, 2025

(54) WIRE HARNESS WIRING STRUCTURE AND WIRE HARNESS

(71) Applicant: Yazaki Corporation, Tokyo (JP)

(72) Inventors: Ryo NAGASHIMA, Shizuoka (JP); Takashi Ookawa, Shizuoka (JP); Masataka Yamamoto, Shizuoka (JP)

(73) Assignee: Yazaki Corporation, Tokyo (JP)

(21) Appl. No.: 19/051,387

(22) Filed: Feb. 12, 2025

(30) Foreign Application Priority Data
Mar. 13, 2024 (JP) 2024-038561

(51) Int. Cl. B60R 16/02

(52) U.S. Cl. CPC B60R 16/0215

(57) ABSTRACT

A wire harness wiring structure includes a wire harness including a wiring member having conductivity and an exterior member configured with a sheet member and attached to the wiring member, and a groove provided in a body of a vehicle and formed along a wiring path of the wire harness. The exterior member includes a body portion formed by bending the sheet member into a cylindrical shape and through which the wiring member can be inserted, an engaging portion capable of engaging ends of the sheet member with each other in a state where the body portion is formed, and a protrusion formed by bending the sheet member outward and having a shape protruding from the body portion. The protrusion is inserted into the groove and fitted into the groove in a state of being elastically deformed in accordance with a shape of the groove.

### CROSS-REFERENCE TO RELATED APPLICATION(S)

The present application claims priority to and incorporates by reference the entire contents of Japanese Patent Application No. 2024-038561 filed in Japan on Mar. 13, 2024.

### BACKGROUND OF THE INVENTION

### 1. Field of the Invention

The present invention relates to a wire harness wiring structure and a wire harness.

### 2. Description of the Related Art

For example, Japanese Patent Application Laid-open No. JP H09-261 826 A discloses a wire harness routing body provided with an attaching part including a pair of tongue segments.

The wire harness routing body described in Japanese Patent Application Laid-open No. JP H09-261 826 A is attached to a car body panel using the spring force of the tongue segments, and the number of assembling steps may increase depending on the method of fixing the wire harness to the vehicle and the assemblability tends to decrease.

### SUMMARY OF THE INVENTION

The present invention has been made in view of the above circumstances, and an object of the present invention is to provide a wire harness wiring structure and a wire harness capable of improving assemblability to a vehicle.

In order to achieve the above mentioned object, a wire harness wiring structure according to one aspect of the present invention includes a wire harness including a wiring member having conductivity and an exterior member configured with a sheet member and attached to the wiring member; and a groove provided in a body of a vehicle and formed along a wiring path of the wire harness, wherein the exterior member includes: a body portion formed by bending the sheet member into a cylindrical shape and through which the wiring member can be inserted; an engaging portion capable of engaging ends of the sheet member with each other in a state where the body portion is formed; and a protrusion formed by bending the sheet member outward and having a shape protruding from the body portion, and the protrusion is inserted into the groove and fitted into the groove in a state of being elastically deformed in accordance with a shape of the groove.

In order to achieve the above mentioned object, a wire harness according to another aspect of the present invention includes a wiring member having conductivity; and an exterior member configured with a sheet member and attached to the wiring member, wherein the exterior member includes: a body portion formed by bending the sheet member into a cylindrical shape and through which the wiring member can be inserted; an engaging portion capable of engaging ends of the sheet member with each other in a state where the body portion is formed; and a protrusion formed by bending the sheet member outward and having a shape protruding from the body portion, and the protrusion is inserted into a groove provided in a body of a vehicle and formed along a wiring path, and fitted into the groove in a state of being elastically deformed in accordance with a shape of the groove.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view illustrating a schematic configuration of a wire harness wiring structure according to the present embodiment;

FIG. 2 is a cross-sectional view illustrating a schematic configuration of a wire harness wiring structure according to the present embodiment; and

FIG. 3 is a cross-sectional view illustrating a schematic configuration of a wire harness wiring structure according to the present embodiment.

### DETAILED DESCRIPTION OF THE PREFERRED EMBODIMENTS

Hereinafter, an embodiment according to the present invention will be described in detail with reference to the drawings. Note that the present invention is not limited to the embodiment. In addition, constituent elements in the following embodiment include those that can be easily replaced by those skilled in the art or those that are substantially the same.

### EMBODIMENT

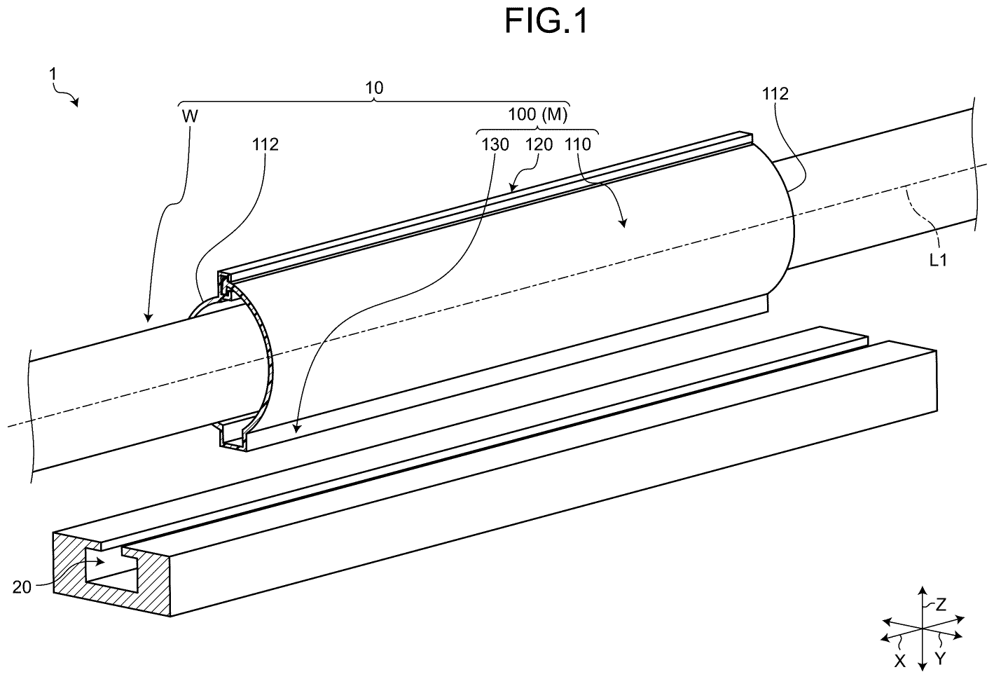

A wire harness wiring structure 1 illustrated in FIG. 1 is applied to a vehicle such as an automobile, and is used for power supply and signal communication by connecting devices mounted in the vehicle.

As illustrated in FIG. 1, the wire harness wiring structure 1 includes a wire harness 10 and a groove 20 provided in a body of a vehicle and formed along a wiring path of the wire harness 10. The wire harness 10 includes a wiring member W having conductivity and an exterior member 100 attached to the wiring member W. In the wire harness wiring structure 1 of the present embodiment, the exterior member 100 is configured with a sheet member M, and a protrusion 130 formed by bending the sheet member M is used as a fitting portion with respect to the groove 20, thereby implementing a configuration in which the assemblability to the vehicle can be improved. Hereinafter, each element of the wire harness wiring structure 1 will be described in detail with reference to FIGS. 1 to 3.

The wire harness 10 may further include a grommet, a fixture, and a connector.

In the following description, among a first direction, a second direction, and a third direction intersecting, the first direction is referred to as a “length direction X”, the second direction is referred to as a “width direction Y”, and the third direction is referred to as a “height direction Z”. Here, the length direction X, the width direction Y, and the height direction Z are orthogonal to each other. The length direction X typically corresponds to a wiring direction of the wire harness 10, a length direction of the groove 20, or the like. The width direction Y typically corresponds to the width direction of the groove 20 or the like. The height direction Z typically corresponds to the height direction (thickness direction) of the groove 20, the fitting direction of the protrusion 130 with respect to the groove 20, or the like. Each direction used in the following description will be explained as a direction in a state where the exterior member 100 is assembled to the groove 20 via the protrusion 130 unless otherwise specified.

### Wire Harness

The wire harness 10 is configured such that a plurality of wiring members W used for power supply and signal communication is bundled to form a collective component for connection between the devices mounted in the vehicle, and the plurality of wiring members W is connected to the devices by a connector or the like. As illustrated in FIGS. 1 to 3, the wire harness 10 of the present embodiment includes the wiring member W and the exterior member 100.

The wiring member W is wired in the vehicle to electrically connect the devices. The wiring member W of the present embodiment is an insulated wire configured to include a conductor portion (core wire) having conductivity and an insulating coating portion with insulating properties, and the conductor portion is coated with the insulating coating portion. The conductor portion herein is a stranded wire in which a plurality of single wires made of conductive metal is twisted together. The insulating coating portion is formed by, for example, extruding an insulating resin material (PP, PVC, cross-linked PE, and the like which are appropriately selected in consideration of abrasion resistance, chemical resistance, heat resistance, and so on) or the like. Note that the conductor portion of the wiring member W may be a bundle of a plurality of single wires. Further, one wiring member W may be used, or a wiring member bundle in which two or more wiring members are bundled may be used.

The exterior member 100 is made of an insulating resin material, and the wiring member W is inserted therethrough. In the exterior member 100, each part is integrally formed by bending the sheet member M having a rectangular shape that is continuously extruded in the longitudinal direction. As illustrated in FIGS. 1 to 3, the exterior member 100 of the present embodiment includes a body portion 110, an engaging portion 120, and the protrusion 130.

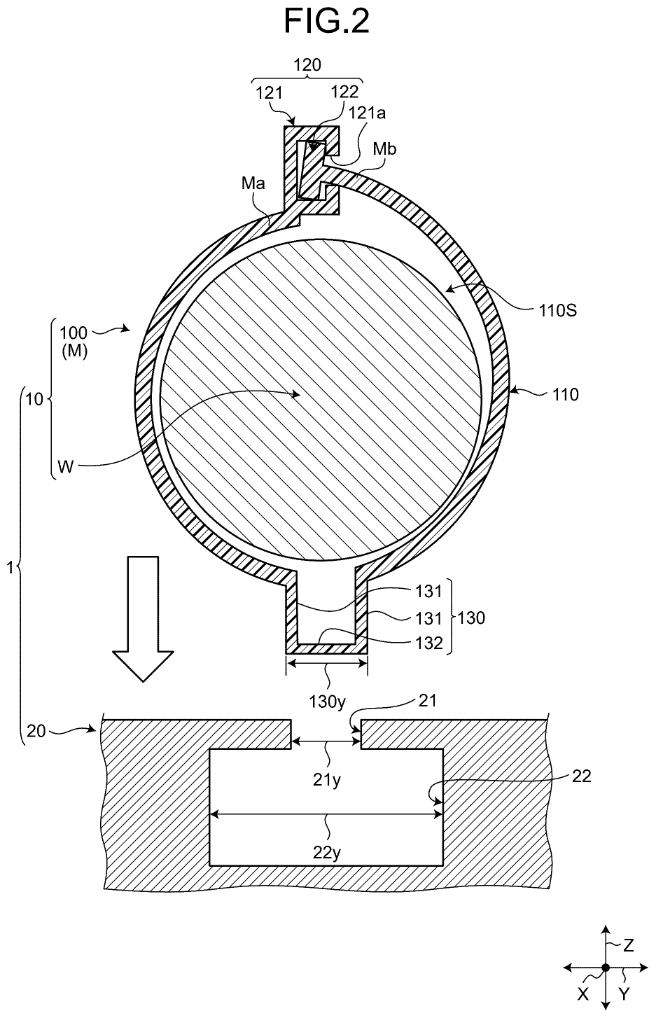

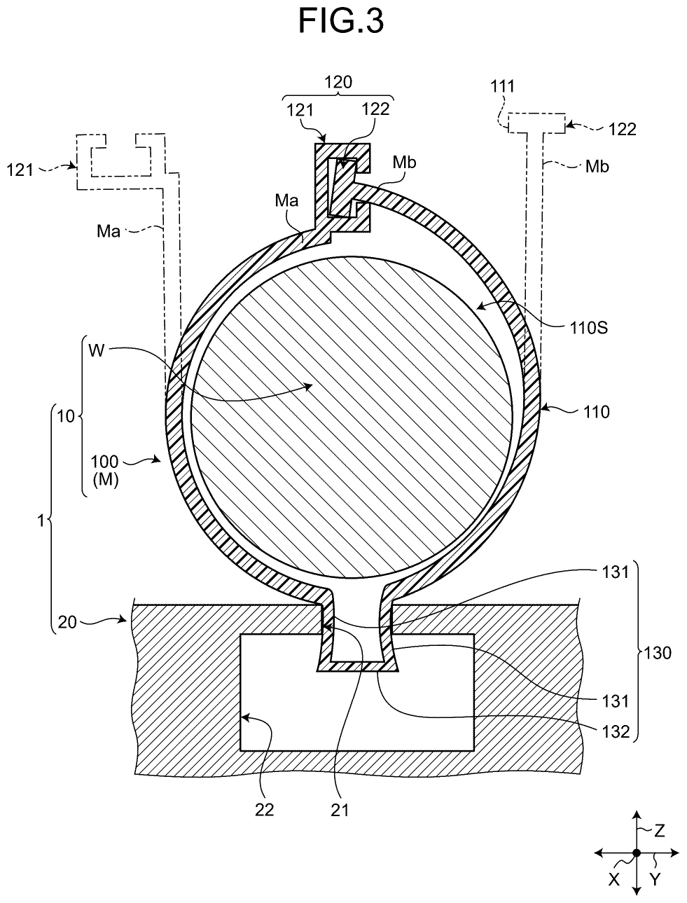

The body portion 110 is a portion through which the wiring member W is inserted. As illustrated in FIGS. 1 to 3, the body portion 110 of the present embodiment is formed by bending the sheet member M into a cylindrical shape, and a cross-sectional shape of the body portion 110 along the height direction Z is formed in a substantially circular shape. The body portion 110 includes a housing space portion 110S (see FIGS. 2 and 3) as an internal space, an attachment opening 111 (see FIG. 3) that opens in the height direction Z, and a pair of insertion openings 112 (see FIG. 1) that opens in the length direction X. Note that the attachment opening 111 herein is an opening formed linearly along the length direction X, and is an opening formed by joining the ends in the lateral direction of the sheet member M bent into a cylindrical shape. The pair of insertion openings 112 is formed at the ends in length direction X of the body portion 110, and is formed using the ends in the longitudinal direction of the sheet member M. Therefore, in the body portion 110 of the present embodiment, the wiring member W is inserted from the attachment opening 111, and the wiring member W is inserted through the housing space portion 110S via the pair of insertion openings 112, whereby the wiring member W can be wired along the length direction X which is the extending direction of the body portion 110 (see FIG. 1).

The engaging portion 120 is a portion that engages the ends (ends Ma and Mb to be described later) of the sheet member M forming the attachment opening 111 of the body portion 110. As illustrated in FIG. 1, the engaging portion 120 of the present embodiment is formed along the longitudinal direction of the sheet member M (the length direction X of the body portion 110). Here, as illustrated in FIGS. 2 and 3, the engaging portion 120 includes a male engaging portion 121 and a female engaging portion 122.

The male engaging portion 121 is a portion that retains the female engaging portion 122. As illustrated in FIGS. 2 and 3, the male engaging portion 121 of the present embodiment is integrally formed with the end Ma on one side in the lateral direction of the sheet member M. The male engaging portion 121 has a substantially C-shaped cross section as viewed in the length direction X, and is provided with a slit 121a into which the female engaging portion 122 can be inserted (see FIG. 2).

The female engaging portion 122 is a portion retained by the male engaging portion 121. As illustrated in FIGS. 2 and 3, the female engaging portion 122 of the present embodiment is integrally formed with the end Mb on the other side in the lateral direction of the sheet member M. The female engaging portion 122 has a substantially T-shaped cross section as viewed in the length direction X, and is formed in a claw shape engageable with the male engaging portion 121. Therefore, in the engaging portion 120 of the present embodiment, the female engaging portion 122 is inserted from the slit 121a of the male engaging portion 121, and the engagement state of the engaging portion 120 (state in which the male engaging portion 121 and the female engaging portion 122 are engaged) is continued, so that the attachment opening 111 of the body portion 110 can be closed (see FIG. 2). In the engaging portion 120, the female engaging portion 122 is removed from the slit 121a of the male engaging portion 121, and the engagement state of the engaging portion 120 is released, so that the attachment opening 111 of the body portion 110 can open (see FIG. 3).

The protrusion 130 is a portion to be fitted to the groove 20. As illustrated in FIG. 1, the protrusion 130 of the present embodiment is provided at the bottom of the body portion 110 and is formed integrally with the body portion 110. The protrusion 130 is formed by bending the sheet member M outward, and has a shape protruding from the body portion 110. Further, the protrusion 130 is formed along the longitudinal direction of the sheet member M (the length direction X of the body portion 110). As illustrated in FIG. 2, the protrusion 130 includes a pair of vertical wall portions 131 and a connecting wall portion 132, and the portions are integrally formed so that a cross-sectional shape of the protrusion 130 as viewed from the length direction X is formed in a substantially U shape.

The pair of vertical wall portions 131 is formed to protrude from the body portion 110. As illustrated in FIG. 2, the pair of vertical wall portions 131 of the present embodiment is formed so as to protrude from the body portion 110 in the height direction Z. In addition, the pair of vertical wall portions 131 is arranged at an interval along the width direction Y, and is provided at positions facing each other along the width direction Y.

The connecting wall portion 132 is a wall portion that connects the vertical wall portions 131 to each other. As illustrated in FIG. 2, the connecting wall portion 132 of the preset embodiment is positioned between the vertical wall portions 131 with respect to the width direction Y, and both ends of the connecting wall portion 132 in the width direction Y are connected to ends of the vertical wall portions 131.

Further, the protrusion 130 is configured to be elastically deformable. When elastically deforming at the time of being inserted into the groove 20, the protrusion 130 abuts on the inner surface of the groove 20 using a reaction force due to the elastic deformation. Therefore, as illustrated in FIG. 3, the protrusion 130 of the present embodiment can be inserted into the groove 20 and fitted to the groove 20 in a state of being elastically deformed in accordance with the shape of the groove 20.

In addition, the protrusion 130 is so configured that once the protrusion 130 is fitted into the groove 20, the state of being fitted into the groove 20 can be maintained independent of the engagement state of the engaging portion 120. Therefore, the engaging portion 120 of the present embodiment can release the engagement state in a state where the protrusion 130 is fitted into the groove 20, and when the engagement state is released in a state where the wire harness 10 is fixed to the groove 20 via the protrusion 130, only the wiring member W inserted through the exterior member 100 can be removed with the exterior member 100 fixed to the groove 20. In addition, the engaging portion 120 can restore the engagement state with the protrusion 130 fitted into the groove 20, and the wiring member W can be attached later to the exterior member 100 fixed to the groove 20 via the protrusion 130.

The engaging portion 120 and the protrusion 130 are provided at positions facing each other along the fitting direction (the height direction Z) of the protrusion 130 with respect to the groove 20. As illustrated in FIGS. 1 to 3, the protrusion 130 is provided on one side (on the groove 20 side, and on the deep side in the fitting direction of the protrusion 130 with respect to the groove 20) in the height direction Z, and the engaging portion 120 is provided on the other side (on the side opposite to the groove 20 side, and on the shallow side in the fitting direction of the protrusion 130 with respect to the groove 20) in the height direction Z. Therefore, in the exterior member 100 of the present embodiment, when the engagement state of the engaging portion 120 is released in a state where the protrusion 130 is fitted into the groove 20, only the wiring member W can be easily removed from a position on the side where the engaging portion 120 is provided. Further, the wiring member W can be easily attached from a position on the side where the engaging portion 120 is provided in a state where the exterior member 100 is fixed to the groove 20 via the protrusion 130.

### Groove

The groove 20 is formed between devices connected by the wire harness 10, and is formed linearly along a preset wiring path (the length direction X in the present embodiment) of the wire harness 10. As illustrated in FIGS. 2 and 3, the groove 20 of the present embodiment includes a narrow portion 21 and a wide portion 22.

The narrow portion 21 is a portion into which the protrusion 130 of the exterior member 100 is inserted. As illustrated in FIG. 2, an opening width 21y of the narrow portion 21 (length of the narrow portion 21 in the width direction Y) is set to be smaller than an opening width 130y of the protrusion 130 (length of the protrusion 130 in the width direction Y). Accordingly, the protrusion 130 of the present embodiment is inserted into the narrow portion 21 by elastically deforming the pair of vertical wall portions 131 inward conforming to the opening width 21y of the narrow portion 21 (see FIG. 3).

The wide portion 22 is a portion that houses the end of the protrusion 130 of the exterior member 100. As illustrated in FIG. 2, the wide portion 22 communicates with the narrow portion 21. Further, an opening width 22y of the wide portion 22 (length of the wide portion 22 in the width direction Y) is set to be larger than the opening width 21y of the narrow portion 21 (length of the narrow portion 21 in the width direction Y). Accordingly, as illustrated in FIG. 3, the protrusion 130 of the present embodiment can be fitted into the groove 20 by bringing the pair of vertical wall portions 131 into contact with the inner surface of the narrow portion 21 using a reaction force (restoring force of the vertical wall portions 131) due to the elastic deformation in a state where the end of the protrusion 130 is housed in the wide portion 22. Further, in the exterior member 100 of the present embodiment, the body portion 110 is fixed to the groove 20 via the protrusion 130, which enables a central axis L1 of the wiring member W inserted through the body portion 110 to be made along the extending direction of the groove 20 (see FIG. 1). Therefore, in the wire harness wiring structure 1 of the present embodiment, the wiring member W can be appropriately wired along the preset wiring path of the wire harness 10.

The wire harness wiring structure 1 described above includes the wire harness 10 and the groove 20 provided in the body of the vehicle and formed along the wiring path of the wire harness 10. In addition, the wire harness 10 includes the wiring member W having conductivity and the exterior member 100 configured with the sheet member M and attached to the wiring member W. The exterior member 100 includes the body portion 110 formed by bending the sheet member M into a cylindrical shape and through which the wiring member W can be inserted, the engaging portion 120 capable of engaging the ends Ma and Mb of the sheet member M with each other in a state where the body portion 110 is formed, and the protrusion 130 formed by bending the sheet member M outward and having a shape protruding from the body portion 110. The protrusion 130 is inserted into the groove 20 and fitted into the groove 20 in a state of being elastically deformed in accordance with the shape of the groove 20.

According to the configuration, in the exterior member 100, the body portion 110 and the protrusion 130 are integrally formed. Therefore, it is not necessary to separately prepare a fixing member such as a clip portion in the wire harness 10, and the wire harness 10 can be manufactured without performing a post-process (for example, a tape winding process or the like) to fix the fixing member to the body portion 110. Further, in the wire harness 10, the exterior member 100 is formed of one sheet member M, which makes it possible to simplify the assembly of the wiring member W with respect to the body portion 110 and the assembly of the protrusion 130 with respect to the vehicle body. Thus, in the wire harness 10, a circuit can be easily changed or added according to a specification change or the like. Then, in the wire harness 10, the protrusion 130 that is elastically deformable is fitted into the groove 20 formed along the preset wiring path, so that the body portion 110 formed integrally with the protrusion 130 and the wiring member W inserted through the body portion 110 can be appropriately fixed along the wiring path of the wire harness 10. Therefore, the wire harness wiring structure 1 of the present embodiment can improve the assemblability to the vehicle.

Further, the engaging portion 120 described above can release the engagement state in a state where the protrusion 130 is fitted into the groove 20. According to the configuration, a worker can remove only the wiring member W inserted through the body portion 110 in a state where the wire harness 10 is fixed to the groove 20 via the protrusion 130. In addition, the worker can attach the wiring member W later in a state where only the exterior member 100 is fixed to the groove 20 via the protrusion 130. Therefore, the worker can appropriately change the order of assembling the wiring member W with respect to the body portion 110 and assembling the protrusion 130 with respect to the vehicle body in accordance with the specifications of the wire harness 10. Therefore, the wire harness wiring structure 1 of the present embodiment can improve the assemblability to the vehicle.

Further, the engaging portion 120 and the protrusion 130 described above are provided at positions facing each other along the fitting direction (the height direction Z) of the protrusion 130 with respect to the groove 20. According to the configuration, the worker can easily remove only the wiring member W from the front side in a state where the wire harness 10 is fixed to the groove 20 via the protrusion 130. Further, the worker can easily attach the wiring member W from the front side in a state where the wire harness 10 is fixed to the groove 20 via the protrusion 130. Therefore, the wire harness wiring structure 1 of the present embodiment can simplify the assembly of the wire harness 10 with respect to the vehicle body to thereby improve the assemblability to the vehicle.

Further, the protrusion 130 described above includes the pair of vertical wall portions 131 formed to protrude from the body portion 110 along the fitting direction (the height direction Z) with respect to the groove 20, and the connecting wall portion 132 for connecting the vertical wall portions 131 to each other. According to the configuration, the protrusion 130 can be fitted into the groove 20 by elastically deforming the pair of vertical wall portions 131 inward conforming to the shape of the groove 20. Therefore, the wire harness wiring structure 1 of the present embodiment can simplify the assembly of the wire harness 10 with respect to the vehicle body to thereby improve the assemblability to the vehicle.

Note that the wire harness wiring structure 1 and the wire harness 10 according to the embodiment of the present invention described above is not limited to the embodiment described above, and various modifications can be made thereto within the scope described in the claims.

For example, the positional relationship between the engaging portion 120 and the protrusion 130 is not particularly limited to the form illustrated in FIGS. 1 to 3.

Further, the shapes of the male engaging portion 121 and the female engaging portion 122 constituting the engaging portion 120 are not particularly limited, provided that the male engaging portion 121 and the female engaging portion 122 can be engaged with each other.

The shape of the protrusion 130 is not particularly limited, provided that the protrusion 130 can be fitted into the groove 20.

The shape (extending direction) of the groove 20 is not particularly limited. In addition, the groove 20 is formed linearly in the above-described embodiment, but may have a curved portion according to the set wiring path of the wire harness 10, and the protrusion 130 is fitted in a curved posture conforming to the shape of the groove 20, so that the wiring member W inserted through the body portion 110 can be appropriately fixed along the wiring path of the curved wire harness 10.

The cross-sectional shape of the groove 20 is not particularly limited.

The wire harness wiring structure 1 and the wire harness 10 according to the present embodiment may be configured by appropriately combining the constituent elements of the embodiment described above.

The wire harness wiring structure and the wire harness according to the present embodiment produce an effect of improving assemblability to a vehicle.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A wire harness wiring structure comprising:
a wire harness including a wiring member having conductivity and an exterior member configured with a sheet member and attached to the wiring member; and
a groove provided in a body of a vehicle and formed along a wiring path of the wire harness, wherein
the exterior member includes:
a body portion formed by bending the sheet member into a cylindrical shape and through which the wiring member can be inserted;
an engaging portion capable of engaging ends of the sheet member with each other in a state where the body portion is formed; and
a protrusion formed by bending the sheet member outward and having a shape protruding from the body portion, and
the protrusion is inserted into the groove and fitted into the groove in a state of being elastically deformed in accordance with a shape of the groove.

2. The wire harness wiring structure according to claim 1, wherein
the engaging portion is configured to be able to release an engagement state with the protrusion fitted into the groove.

3. The wire harness wiring structure according to claim 1, wherein
the engaging portion and the protrusion are provided at positions facing each other along a fitting direction of the protrusion with respect to the groove.

4. The wire harness wiring structure according to claim 2, wherein
the engaging portion and the protrusion are provided at positions facing each other along a fitting direction of the protrusion with respect to the groove.

5. The wire harness wiring structure according to claim 1, wherein
the protrusion includes a pair of vertical wall portions formed to protrude from the body portion along a fitting direction with respect to the groove, and a connecting wall portion connecting the vertical wall portions to each other.

6. The wire harness wiring structure according to claim 2, wherein
the protrusion includes a pair of vertical wall portions formed to protrude from the body portion along a fitting direction with respect to the groove, and a connecting wall portion connecting the vertical wall portions to each other.

7. A wire harness comprising:
a wiring member having conductivity; and
an exterior member configured with a sheet member and attached to the wiring member, wherein
the exterior member includes:
a body portion formed by bending the sheet member into a cylindrical shape and through which the wiring member can be inserted;
an engaging portion capable of engaging ends of the sheet member with each other in a state where the body portion is formed; and
a protrusion formed by bending the sheet member outward and having a shape protruding from the body portion, and
the protrusion is inserted into a groove provided in a body of a vehicle and formed along a wiring path, and fitted into the groove in a state of being elastically deformed in accordance with a shape of the groove.
